(19) United States
(12) Patent Application Publication
(10) Pub. No.: US 2014/0342342 A1
(43) Pub. Date: Nov. 20, 2014

(54) SYSTEMS AND METHODS THAT UTILIZE TOUCH-SCREEN TECHNOLOGY TO PROVIDE USER-CENTRIC EDUCATIONAL TRAINING

(71) Applicant: Case Western Reserve University, Cleveland, OH (US)

(72) Inventors: Colin K. Drummond, Lakewood, OH (US); James R. Rowbottom, Broadview Heights, OH (US); John M. Craker, Highland Heights, OH (US); Olivia H. He, Cleveland, OH (US)

(73) Assignee: Case Western Reserve University, Cleveland, OH (US)

(21) Appl. No.: 14/277,289

(22) Filed: May 14, 2014

Related U.S. Application Data
(60) Provisional application No. 61/823,220, filed on May 14, 2013.

(51) Int. Cl. G09B 7/06

(52) U.S. Cl. CPC G09B 7/06
USPC 434/362

(57) ABSTRACT

One aspect of the present disclosure relates to a system that can provide user-centric training. The system can include a touch screen that can be configured to receive a touch input from a user. The system can also include a non-transitory memory that stores instructions and a processor that can be configured to execute the instructions to at least: receive the touch input (that corresponds to a first node of a concept map related to a question) from the user in response to the question; create a user generated concept map based on a connection between the first node and a second node of the concept map related to the question; and score the touch input based on the connection in response to the question.

### RELATED APPLICATIONS

This application claims the benefit of U.S. Provisional Application No. 61/823,220, filed May 14, 2013, entitled “LAYERED CONCEPT MAP ARCHITECTURE FOR CLINICAL TRAINING AND EDUCATION.” This provisional application is hereby incorporated by reference in their entireties for all purposes.

### TECHNICAL FIELD

The present disclosure relates generally to education and, more specifically, to systems and methods that can utilize touch-screen technology to provide user-centric educational training.

### BACKGROUND

Conventional instructional methods (e.g., lectures and textbooks), in which instruction is presented to the student in its final form, generally lead to passive, rote learning. While rote learning is an easy teaching method for instructors, rote learning is not always the best learning method for students, especially when they need to understand integration between concepts. With rote learning, students can only memorize discrete information about concepts, generally without integration between the concepts. In situations where the students need to understand integration between concepts, meaningful learning, which can occur by the assimilation and integration of new concepts into existing concepts, can be beneficial to the students.

One example of a teaching technique that can promote meaningful learning is a concept map. A concept map can provide a visual representation of a cognitive structure as a reference for new concepts. Each concept map can be which is based on an original idea defined by a focus question. Every concept represented in the concept map can relate back to the focus question in some manner. The concept map can depict suggested relationships between concepts, revealing connections between the concepts. For example, clinical training frequently features concept maps as a learning tool for medical knowledge because clinical students need to see relationships between concepts they may see in patients to facilitate diagnosis and treatment).

### SUMMARY

The present disclosure relates generally to education and, more specifically, to systems and methods that can utilize touch-screen technology to provide user-centric educational training.

In one aspect, the present disclosure can include a system that can provide user-centric training. The system can include a touch screen that can be configured to receive a touch input from a user. The system can also include a non-transitory memory that stores instructions and a processor that can be configured to execute the instructions. The touch input can be received from the user in response to a question (e.g., a focus question). The touch input can correspond to a first node of a concept map related to the question. A user generated concept map can be created based on a connection between the first node and a second node of the concept map related to the question. The touch input can be scored based on the connection in response to the question. For example, the connection can represent a relationship between concepts related to the question.

In another aspect, the present disclosure can include a method for educating a user about a subject area. The method can include the step of receiving an input in response to a question about the subject area (e.g., a focus question). The input can be received from a touch screen input device. The question can be related to a first node of a concept map related to the subject area. The method can also include the step of linking, by a system comprising a processor, the input to a second node of the concept map. The method can also include the step of determining, by the system, whether the link provides a correct association in response to the question or an incorrect association in response to the question. For example, the link can represent a relationship between concepts related to the question.

In a further aspect, the present disclosure can include a method for educating a user about a subject area. The method can include the step of receiving an input in response to a question about the subject area. The input can be received from a touch screen device. The question can be related to a first node of a concept map related to the subject area. The method can also include the step of linking, by a system comprising a processor, the input to a second node of the concept map. The method can also include determining, by the system, whether the link provides a correct association in response to the question or an incorrect association in response to the question.

### BRIEF DESCRIPTION OF THE DRAWINGS

The foregoing and other features of the present disclosure will become apparent to those skilled in the art to which the present disclosure relates upon reading the following description with reference to the accompanying drawings, in which:

FIG. 1 is schematic block diagram of a system that can utilize a layered concept map approach to provide user-centric training in accordance with an aspect of the present disclosure;

FIG. 2 is a schematic diagram showing an example of an expert concept match that can be used in the layered concept map approach of the system shown in FIG. 1;

FIGS. 3-5 are a schematic diagrams showing examples of novice concept maps with different errors that can be detected using the layered concept map approach of the system shown in FIG. 1;

FIG. 6 is a process flow diagram illustrating a method for providing user-centric training according to a layered concept map approach in accordance with another aspect of the present disclosure; and

FIG. 7 is a process flow diagram illustrating a method for diagnosing a user's competence about a subject area in response to a concept map created according to the method shown in FIG. 6.

### DETAILED DESCRIPTION

### I. Definitions

In the context of the present disclosure, the singular forms “a,” “an” and “the” can also include the plural forms, unless the context clearly indicates otherwise. The terms “comprises” and/or “comprising,” as used herein, can specify the presence of stated features, steps, operations, elements, and/or components, but do not preclude the presence or addition of one or more other features, steps, operations, elements, components, and/or groups. As used herein, the term “and/or” can include any and all combinations of one or more of the associated listed items. Additionally, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present disclosure. The sequence of operations (or acts/steps) is not limited to the order presented in the claims or figures unless specifically indicated otherwise.

As used herein, the term “touch screen” can refer to a touch-sensitive display device that provides a user interface that allows a user to interact with a computing device by touching (e.g., with a finger or a stylus) one or more areas on the screen.

As used herein, the term “computing device” can refer to a device that includes a non-transitory memory that stores instructions and a processor configured to execute the instructions to facilitate performance of one or more operations. In some instances, the non-transitory memory can also store data corresponding to the one or more operations. The term “mobile computing device” can refer to a subset of computing devices that include a touch screen. Examples of mobile computing devices can include: a smart phone, a tablet computer, or a laptop computer.

As used herein, the term “user” can refer to a human being that can interact with the touch screen of a mobile computing device. In some instances, the user can be a student (or “novice”). In other instances, the user can be a teacher (or “expert”).

As used herein, the term “learning” can refer to the acquisition of knowledge. In some instances, learning can be grouped into “rote” or “didactic” learning (e.g., in which instruction is presented to the student in its final form) and “meaningful” or “dialectic” learning (e.g., in which new concepts can be assimilated and integrated into existing concepts). The terms “rote” and “didactic” can be used interchangeably herein. Additionally, the terms “meaningful” and “dialectic” can be used interchangeably herein.

As used herein, “education” can relate to a process that can facilitate didactic and/or dialectic learning.

As used herein, the term “concept map” can refer to a visual representation of a cognitive structure that can be used as a reference for new concepts. In some instances, the concept map can be used to help students (or novices) organize and represent knowledge of a subject. In some instances, a concept map can be based on a main (or original) idea that can be defined by a “focus question.” Every concept represented in the concept map can relate back to the focus question in some manner. The concept map can depict suggested relationships between concepts, revealing connections between concepts. For example, different concepts (that can be represented by nodes of a hierarchy) can branch out from the main idea to show how the main idea can be broken down into specific topics. The different nodes can be located at different hierarchical levels with respect to the main idea. In another example, the different nodes connect to other concepts between levels of the hierarchy. In some instances, an “expert concept map” can correspond to a generally accepted concept map based on a focus question. A “novice concept map” or “user concept map” can correspond to a concept map that can be created by a student. The novice concept map can be matched with the expert concept map, and errors can be determined that can correspond to errors in cognition.

As used herein, the term “automatic” can refer to a process that operates by itself with little to no direct human control. In some instances, an automatic process can operate with no direct human control other than an initial input. For example, after receiving an input from a touch screen, a mobile computing device can produce an output without additional human input.

As used herein, the term “dynamic” can refer to a process that is characterized by quick changes. For example, data storage within a student's brain can change dynamically with learning.

As used herein, the term “real-time” can refer to a system or method in which input data is processed quickly (e.g., within milliseconds) so that feedback related to the data it is available immediately or almost immediately (e.g., within milliseconds).

### II. Overview.

The present disclosure relates generally to education and, more specifically, to systems and methods that can utilize touch-screen technology to provide user-centric educational training. The user-centric training can facilitate dialectic learning, in which students can visualize relationships between concepts. For example, the systems and methods described herein can utilize layered concept maps to facilitate the dialectic learning for the students.

In some instances, the systems and methods of the present invention can be utilized for clinical training applications in medical education. With traditional clinical training methods, students can study and memorize a clinical protocol and then put the clinical protocol to use. For example, after memorizing the clinical protocol, the student can apply the clinical protocol as memorized to a patient presenting with certain conditions. The student can present a recommendation for a diagnosis or treatment based on the memorized clinical protocol. If the recommendation is incorrect, the student can go back to study and memorize the clinical protocol again, while reflecting on the variance of the recommendation from the recommended practice of the clinical protocol. These traditional clinical training methods cannot recognize and identify the student's lack of cognition of the clinical protocol before the incorrect recommendation.

In contrast, the layered concept match approach of the systems and methods described herein can identify the lack of cognition in real-time and during situations where the student may be experiencing a high level of stress. Employing the layered concept map approach, the systems and methods described herein can automatically and dynamically track user navigation through a concept map representing the clinical protocol to identify the lack of cognition before the incorrect recommendation or diagnosis. A layered concept map can include two or more layers. A first layer (n=1) can be linked to a touch screen to receive inputs that facilitate the selection and/or construction of a novice concept map (e.g., created by the student) related to a focus question (e.g., based on the clinical protocol). A second and any subsequent layer (n>1) can be linked to an expert concept map (e.g., stored in a non-transitory memory of a mobile computing device) related to the focus question. The inputs received from the touch screen interface can be compared to the expert concept map, and errors related to the input can be identified in real-time.

### III. Systems

One aspect of the present disclosure can include a system that can that can provide user-centric training according to a layered concept map approach. The system can utilize a mobile computing device with a touch screen input device to facilitate the user-centric training. Advantageously, the user-centric training can identify a lack of cognition (e.g., due to a didactic error or a dialectic error). Moreover, since the systems can be embodied on a mobile computing device, students can use the systems in any situation to test their knowledge of a specific area. For example, the systems can be used when the student is placed in a stressful situation (e.g., before an examination).

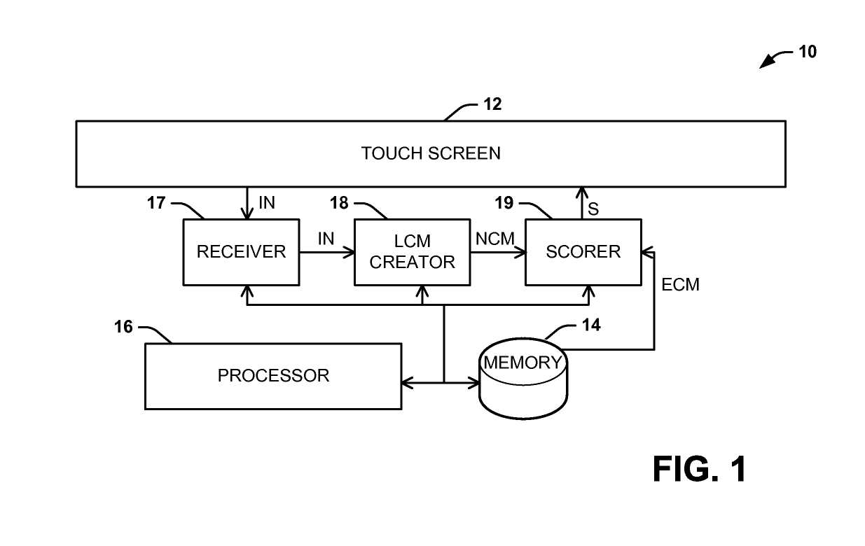

FIG. 1 illustrates an example of a system 10 that can provide user-centric training according to a layered concept map approach, according to an aspect of the present disclosure. FIG. 1 is schematically illustrated as a block diagram with the different blocks representing different components. The functions of one or more of the components can be implemented by computer program instructions. These computer program instructions can be provided to a processor of a general purpose computer, special purpose computer, and/or other programmable data processing apparatus to produce a machine, such that the instructions, which execute via the processor of the computer and/or other programmable data processing apparatus, create a mechanism for implementing the functions of the components specified in the block diagrams.

These computer program instructions can also be stored in a non-transitory computer-readable memory that can direct a computer or other programmable data processing apparatus to function in a particular manner, such that the instructions stored in the non-transitory computer-readable memory produce an article of manufacture including instructions, which implement the function specified in the block diagrams and associated description.

The computer program instructions can also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions of the components specified in the block diagrams and the associated description.

Accordingly, the components described herein can be embodied at least in part in hardware and/or in software (including firmware, resident software, micro-code, etc.). Furthermore, aspects of the components can take the form of a computer program product on a computer-usable or computer-readable storage medium having computer-usable or computer-readable program code embodied in the medium for use by or in connection with an instruction execution system. A computer-usable or computer-readable medium can be any non-transitory medium that is not a transitory signal and can contain or store the program for use by or in connection with the instruction or execution of a system, apparatus, or device. The computer-usable or computer-readable medium can be, for example but not limited to, an electronic, magnetic, optical, electromagnetic, infrared, or semiconductor system, apparatus or device. More specific examples (a non-exhaustive list) of the computer-readable medium can include the following: a portable computer diskette; a random access memory; a read-only memory; an erasable programmable read-only memory (or Flash memory); and a portable compact disc read-only memory. In some instances, the system 10 can be executed by a mobile computing device that includes a touch screen.

As shown in FIG. 1, one aspect of the present disclosure can include a system 10 configured to can provide user-centric training according to a layered concept map approach. In some instances, the system 10 can be used to provide clinical training to students (e.g., medical students and/or medical residents). However, system 10 can be used in any situation to provide training to a user. For example, system 10 can be used to teach a student (e.g., a primary, secondary, or post-secondary student) about a concept in the school curriculum. In another example, the system 10 can be used to refresh the training of a helicopter medic.

The system 10 can be embodied in a mobile computing device that includes a touch screen 12. The system 10 can provide real-time training to the student related to the focus question. For example, since the system 10 can be embodied on a mobile computing device that can be used in almost any situation, feedback identifying the lack of cognition can be provided both in real-time and during situations where the student may be experiencing a high level of stress (e.g., when using the mobile computing device as a study tool immediately before an examination).

The touch screen 12 can be a user interface that a user can touch (e.g., with a finger and/or a stylus device) to provide an input (IN). The touch screen 12 can also provide a display (e.g., a graphical user interface) that can provide different areas on the touch screen for the user to interact with to provide the input.

The system 10 can include components including at least a receiver 17, an LCM creator 18, and a scorer 19. The components can be stored in a non-transitory memory 14 and executed by processor 16 to facilitate the performance of operations associated with the components.

The receiver 17 can be configured to receive the touch screen input (IN) from the user. In some instances, the receiver can correlate the input (IN) to one or more graphics displayed on the touch-screen and discern that the input (IN) corresponds to a specific item displayed on the touch screen display and/or to a specific motion related to the specific item.

In some instances, the touch screen display can be related to a concept map based on a question (e.g., a focus question related to a specific area of education). For example, the question, “What is pulmonary shunting?” can be related to the area of oxygen transport. In another example, the question, “What is entrepreneurship?” can be related to the area of entrepreneurship.

The receiver 17 can provide the input (IN) to the LCM creator 18. The LCM creator 18 can determine that the touch input corresponds to a first node of a novice concept map (NCM) created by the user. The LCM creator 18 can facilitate the creation of the novice concept map (NCM). In some instances, the novice concept map (NCM) can be displayed by the touch screen display upon in real-time upon receiving the input (IN).

A generally accepted (“expert”) concept map (ECM) can be stored in the non-transitory memory 14 of the mobile computing device and/or in a non-transitory memory that is networked with the mobile computing device (e.g., located remote to the mobile computing device). The novice concept map (NCM) and the expert concept map (ECM) can be provided to the scorer 19 to determine a score (S) of the input and/or the entire novice concept map (NCM) with respect to the expert concept map (ECM). In some instances, the score (S) can identify any lack of cognition related to the focus question based on the input (IN) and/or the entire novice concept map (NCM).

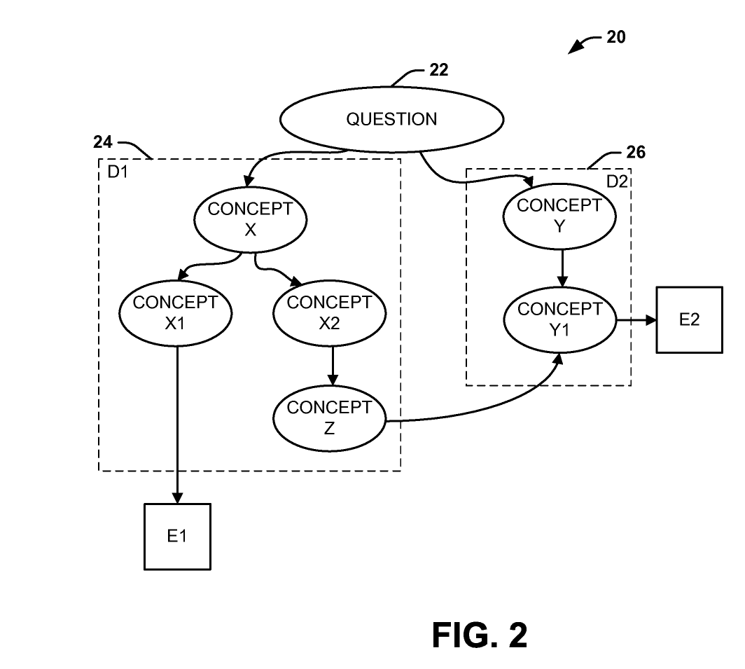

The system 10 can employ a “layered concept map” approach to automatically and dynamically track user navigation through the expert concept map (ECM). A simple example 20 of an expert concept map (ECM) that can facilitate meaningful learning is shown in FIG. 2.

The expert concept map (ECM) can be based on a question 22 (related to an overarching concept). The question can define one or more domains. The example 20 illustrates two domains (e.g., D1 24 and D2 26). The domains (e.g., D1 24 and D2 26) can reflect different facets of information and concepts that can be related to the question.

Each domain (e.g., D1 24 and D2 26) can have a different higher level concept (e.g., concept X and concept Y). Additional concepts can build from the higher level concepts, adding more levels of specificity (e.g., concepts X1 and X2 relate to concept X and concepts Y1 relates to concept Y). In other words, the expert concept map (ECM) can be hierarchically structured with different levels corresponding to different levels of granularity (e.g., concept X1 is more specific than concept X).

The example 20 also shows cross-linking between domains relevant to the question 22 (e.g., concept Z from D1 24 is linked to concept Y1 of D2 26). Cross-linking of concepts across knowledge domains (e.g., D1 24 and D2 26) can show how the domains (e.g., D1 24 and D2 26) can be related to each other.

Referring again to FIG. 1, the scorer 19 can determine the score based on a layered concept map that can include two or more layers. A first layer (n=1) can be linked to a touch screen to receive one or more inputs (IN) (received by the receiver 17) that facilitate the selection and/or construction of a novice concept map (NCM) (by the LCM creator 18) related to a focus question. Any subsequent layer (n>1) can be linked to one or more expert concept map (ECM) (e.g., stored in the non-transitory memory 14) related to the focus question. The scorer 19 can compare the one or more inputs (IN) to the expert concept map. The scorer 19 can identify errors related to the input can be identified real-time.

In some instances, at least a portion of the expert concept map (ECM) can be displayed on the touch screen 12. A user can fill in missing portions of the expert concept map (ECM) using the touch screen input (IN). For example, a plurality of possible concepts can be displayed by the touch screen, and the input (IN) can move each of the plurality of possible concepts to the proper place within the concept map. In another example, the input (IN) be a text input that can fill in one or more blanks within the expert concept map (ECM).

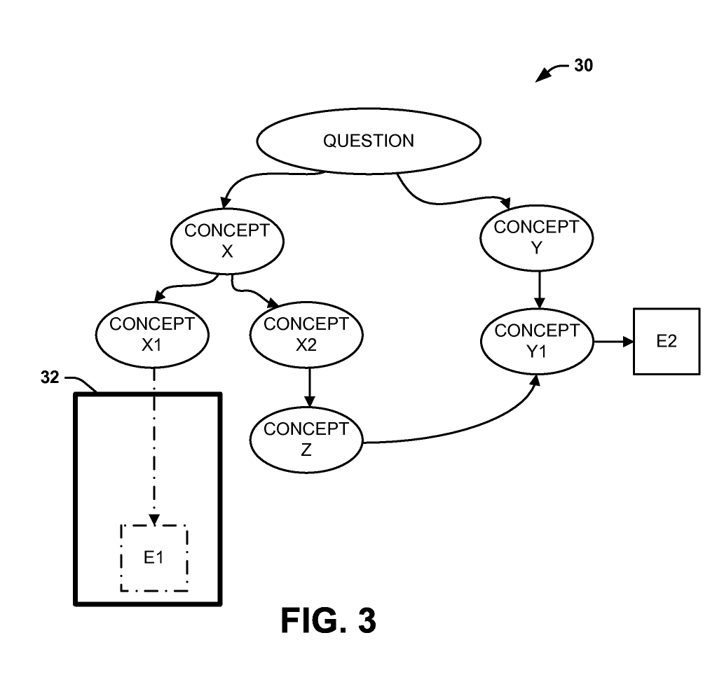

The scorer 19 can determine various errors relate to the novice concept map (NCM). Examples of the types of errors that the scorer 19 can determine are shown in FIGS. 3-5.

FIG. 3 illustrates an example 30 of a “type 1” error. The type 1 error can relate to a missing concept from the concept map. For example, in example 30, the connection 32 from concept X1 to example E1 is missing. The type 1 error can be a didactic error that can be aided by rote learning.

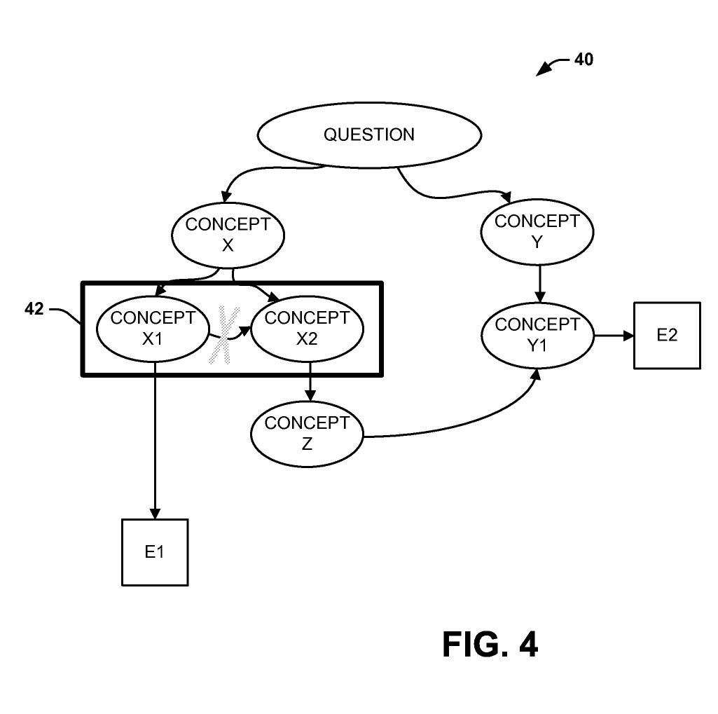

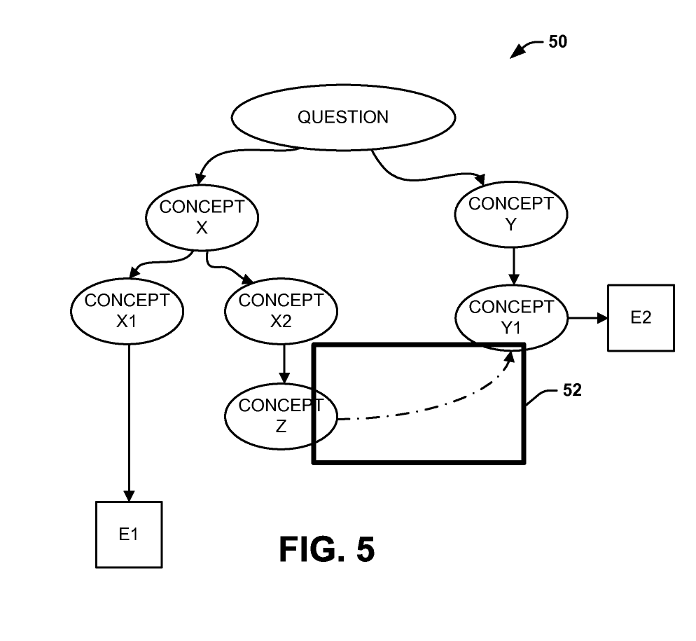

FIG. 4 illustrates a “type 2” error. FIG. 5 illustrates a “type 3” error. Type 2 and type 3 errors each relate to errors with regard to linkage between concepts. FIG. 4 shows an example 40 of an error in linkage with regard to concepts on the same hierarchical level. For example, FIG. 4 illustrates an incorrect link 42 between concept X1 and concept X2. FIG. 5 shows an example 50 of an error in linkage with regard to concepts on different hierarchical levels. For example, FIG. 4 illustrates a missing link 52 between concept Z and concept Y1. Accordingly, type 2 and type 3 errors are dialectic errors that generally cannot be aided by rote learning because the student knows the concept, but does not understand the integration between concepts.

Referring again to FIG. 1, the scorer 19 can identify the type of error (e.g., type 1, type 2, or type 3). In some instances, the scorer 19 can employ a search and score algorithm to compare the novice concept map (NCM) and expert concept map (ECM). The search and score algorithm can (1) compare concepts to identify any missing didactic concepts in the novice concept map (NCM) (e.g., type 1 errors); (2) examine different hierarchical levels of the concept match to identify missing links between concepts on the same levels of the novice concept map (NCM) (e.g., type 2 errors); and (3) examine cross-links between hierarchical levels (e.g., type 3 errors). The score determined by the scorer 19 can indicate whether there is a deficiency in rote knowledge of the concepts (e.g., type 1 error) and/or whether there is a deficiency in critical thinking skills that require the student to develop links between concepts (e.g., type 2 error and/or type 3 error). For example, the scorer 19 can employ a linear hierarchical modeling (LHM) technique to determine the type of deficiency. The LHM technique can be based multi-level regression modeling.

The score (S) can be displayed on the touch screen 12 (e.g., correct, incorrect (didactic error or dialectic error). In some instances, the score (S) can include further recommendations for the student for further study. For example, for the same focus question, different expert concept maps (ECM) with different levels of complexity can be geared to different levels of user experience. The scorer 19 can recommend that the student review a lower level concept map.

In other instances, the score (S) can be saved with results from other users (e.g., in a historical database). An instructor can examine the saved results to determine if a pattern exists between errors made by the student. For example, if a large number of students make the same mistake related to the concept map, the instructor can change her teaching method related to the error and/or update the expert concept map in response to the error.

### IV. Methods

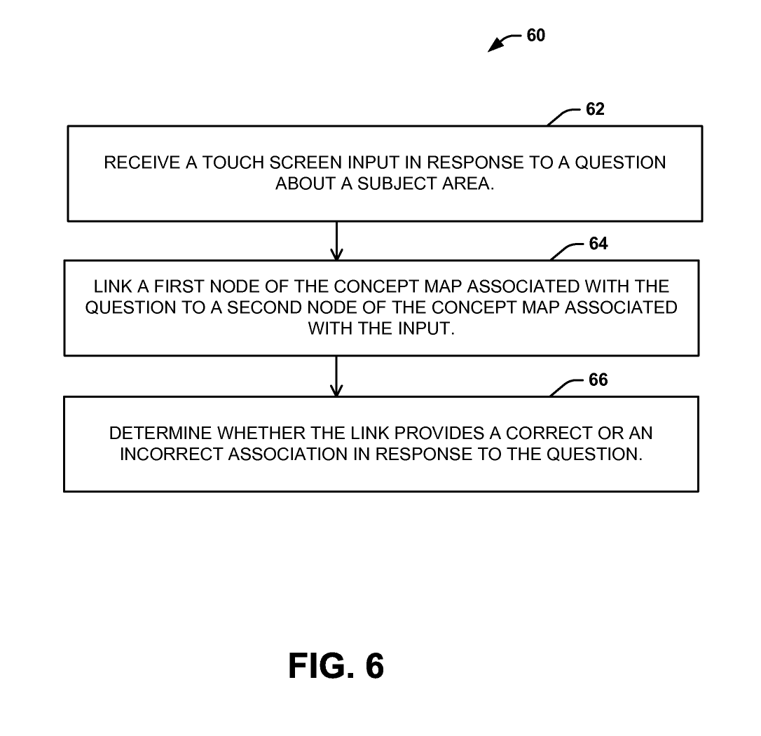

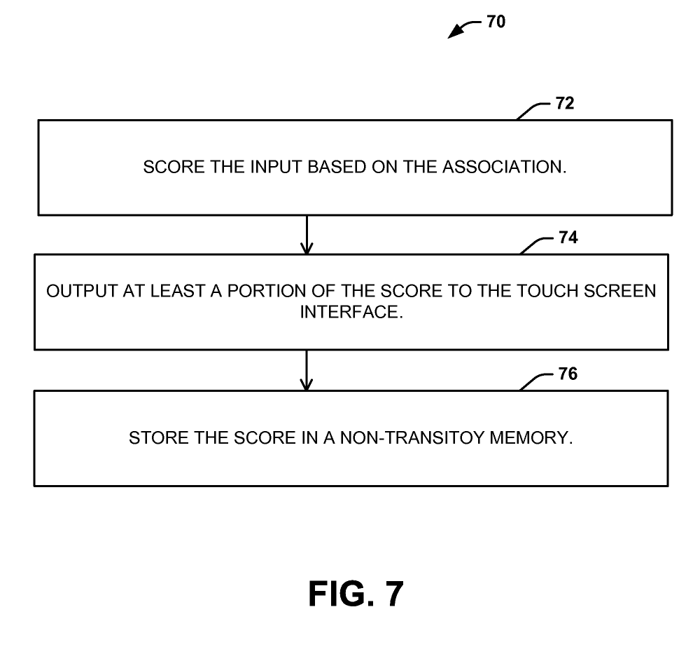

Another aspect of the present disclosure can include methods that can provide user-centric training, according to an aspect of the present disclosure. The methods can employ a “layered concept map” approach to automatically and dynamically track user navigation through an expert concept map (e.g., by creation of a novice concept map). An example of a method 60 that can provide user-centric training according to a layered concept map approach is shown in FIG. 6. Another example of a method 70 that can diagnose a user's competence about a subject area in response to a concept map (e.g., created via the method 60) is shown in FIG. 7.

In some instances, the methods 60 and 70 can be used to provide clinical training to students (e.g., medical students and/or medical residents). However, system 10 can be used in any situation to provide training to a user. For example, the methods 60 and 70 can be used to teach a student (e.g., a primary, secondary, or post-secondary student) about a concept in the school curriculum. In another example, the methods 60 and 70 can be used to refresh the training of a helicopter medic.

The methods 60 and 70 of FIGS. 6 and 7, respectively, are illustrated as process flow diagrams with flowchart illustrations. For purposes of simplicity, the methods 60 and 70 are shown and described as being executed serially; however, it is to be understood and appreciated that the present disclosure is not limited by the illustrated order as some steps could occur in different orders and/or concurrently with other steps shown and described herein. Moreover, not all illustrated aspects may be required to implement the methods 60 and 70.

One or more blocks of the respective flowchart illustrations, and combinations of blocks in the block flowchart illustrations, can be implemented by computer program instructions. These computer program instructions can be stored in memory and provided to a processor of a general purpose computer, special purpose computer, and/or other programmable data processing apparatus to produce a machine, such that the instructions, which execute via the processor of the computer and/or other programmable data processing apparatus, create mechanisms for implementing the steps/acts specified in the flowchart blocks and/or the associated description. In other words, the steps/acts can be implemented by a system comprising a processor that can access the computer-executable instructions that are stored in a non-transitory memory.

The methods 60 and 70 of the present disclosure may be embodied in hardware and/or in software (including firmware, resident software, micro-code, etc.). Furthermore, aspects of the present disclosure may take the form of a computer program product on a computer-usable or computer-readable storage medium having computer-usable or computer-readable program code embodied in the medium for use by or in connection with an instruction execution system. A computer-usable or computer-readable medium may be any non-transitory medium that can contain or store the program for use by or in connection with the instruction or execution of a system, apparatus, or device.

Referring to FIG. 6, an aspect of the present disclosure can include a method 60 for providing user-centric training according to a layered concept map approach. The method 60 can be executed by a mobile computing device with a touch screen input device (e.g., touch screen 12) to facilitate the user-centric training. Advantageously, the user-centric training can identify a lack of cognition (e.g., due to a didactic error or a dialectic error). Moreover, since the systems can be embodied on a mobile computing device, students can use the systems in any situation to test their knowledge of a specific area. For example, the systems can be used when the student is placed in a stressful situation (e.g., before an examination).

At 62, a touch screen input (e.g., IN) can be received (e.g., by receiver 17) in response to a question about a subject area. In some instances, the input can be correlated to a function related to one or more graphics displayed on the touch-screen. In some instances, the touch screen display can be related to a concept map based on a question (e.g., a focus question related to a specific area of education). For example, the question, “What is pulmonary shunting?” can be related to the area of oxygen transport. In another example, the question, “What is entrepreneurship?” can be related to the area of entrepreneurship.

At 64, first node of the concept map associated with the question can be linked (e.g., by LCM creator 18) to a second node of the concept map associated with the input. The concept map can be a novice concept map (e.g., NCM) created by the user. In some instances, further inputs can be received and the novice concept map can be created with different links between nodes.

At 66, the link can be determined (e.g., by scorer 19) to provide a correct or an incorrect association in response to the question. The link can be compared to generally accepted links defined by an expert concept map (e.g., ECM). In some instances, a score (e.g., S) associated with the determination can identify any lack of cognition related to the focus question.

FIG. 7 illustrates a method 70 for diagnosing a user's competence about a subject area in response to a concept map created according to the method 60 shown in FIG. 6. The method 70 can identify a type of error made by the user (e.g., type 1, type 2, or type 3). Based on the type of error, the method 70 can determine if the error is didactic or dialectic. For example, the scorer 19 can employ a linear hierarchical modeling (LHM) technique to determine the type of deficiency. The LHM technique can be based multi-level regression modeling.

At 72, the input can be scored (e.g., by scorer 19) based on the association. In some instances, the input can be scored based on a search and score algorithm that compares the input and/or the associated novice concept map to at least a portion of the corresponding expert concept map. For example, the search and score algorithm can: (1) compare concepts to identify any missing didactic concepts in the novice concept map (e.g., type 1 errors); (2) examine different hierarchical levels of the concept match to identify missing links between concepts on the same levels of the novice concept map (e.g., type 2 errors); and (3) examine cross-links between hierarchical levels (e.g., type 3 errors). The score can indicate whether there is a deficiency in rote knowledge of the concepts (e.g., type 1 error) and/or whether there is a deficiency in critical thinking skills that require the student to develop links between concepts (e.g., type 2 error and/or type 3 error).

At 74, at least a portion of the score can be output to the touch screen interface. In some instances, the portion of the score can indicate whether the association was correct or incorrect. In some instances, an incorrect association can be associated with a didactic error or a dialectic error. In some instances, the displayed score can include further recommendations for the student for further study. For example, for the same focus question, different expert concept maps with different levels of complexity can be geared to different levels of user experience. The scorer 19 can recommend that the student review a lower level concept map.

At 76, the score can be stored in a non-transitory memory. For example, the memory can be within the mobile computing device (e.g., non-transitory memory 14) and/or at a remote location and networked with the mobile computing device. In some instances, the score can be saved with results from other users (e.g., in a historical database). An instructor can examine the saved results to determine if a pattern exists between errors made by the student. For example, if a large number of students make the same mistake related to the concept map, the instructor can change her teaching method related to the error and/or update the expert concept map in response to the error.

From the above description, those skilled in the art will perceive improvements, changes and modifications. Such improvements, changes and modifications are within the skill of one in the art and are intended to be covered by the appended claims.

What is claimed is:

1. A system that provides user-centric training, the system comprising:
a touch screen configured to receive a touch input from a user;
a non-transitory memory that stores instructions; and
a processor configured to execute the instructions to at least:
receive the touch input from the user in response to a question, wherein the touch input corresponds to a first node of a concept map related to the question;
create a user generated concept map based on a connection between the first node and a second node of the concept map related to the question; and
score the touch input based on the connection in response to the question.

2. The system of claim 1, wherein the score is based on a comparison between a second connection between a correct node and the second node and the connection.

3. The system of claim 2, wherein the touch input comprises a selection of a first option from a plurality of different options, and
wherein at least one of the plurality of different options corresponds to the correct node.

4. The system of claim 3, wherein the comparison indicates that the first option is at least one of correctly connected to the second node and incorrectly connected to the second node.

5. The system of claim 4, wherein the score indicates that the first option is at least one of correct, a didactic error, and a dialectic error.

6. The system of claim 1, wherein the processor is further configured to execute the instructions to display the score on the touch screen.

7. The system of claim 1, wherein the concept map comprises a hierarchical arrangement of a plurality of nodes comprising the first node and the second node.

8. The system of claim 7, wherein the first node and the second node are on the same level of the concept map.

9. The system of claim 7, wherein the first node and the second node are on different levels of the concept map.

10. The system of claim 7, wherein the score is related to a hierarchical arrangement of the first node and the second node.

11. The system of claim 1, wherein the concept map related to the question is configured with a plurality of concept maps that are each related to a different level of complexity.

12. A method for educating a user about a subject area, comprising the steps of:
receiving, from a touch screen, an input in response to a question about the subject area, wherein the question is related to a first node of a concept map related to the subject area;
linking, by a system comprising a processor, the input to a second node of the concept map; and
determining, by the system, whether the link provides a correct association in response to the question or an incorrect association in response to the question.

13. The method of claim 12, further comprising the step of displaying, by the processor on the touch screen, a score corresponding to the determination of whether the link provides the correct association in response to the question or the incorrect association in response to the question.

14. The method of claim 13, further comprising the step of storing, by the system, the determination of whether the link provides the correct association in response to the question or the incorrect association in response to the question.

15. The method of claim 14, further comprising the steps of:
analyzing, by the system, a plurality of stored determinations of whether the link provides the correct association in response to the question or the incorrect association in response to the question related to a plurality of users; and
evaluating, by the system, whether the correct association is in line with an accepted association.

16. A method for diagnosing a user's competence about a subject area, comprising the steps of:
receiving, from a touch screen, an input in response to a question about the subject area, wherein the question is related to a first node of a concept map related to the subject area;
linking, by a system comprising a processor, the input to a second node of the concept map; and
scoring, by the system, the user's competence based on a comparison between the link and a correct link in response to the question.

17. The method of claim 16, further comprising the steps of:
providing, by the system, a second question about the subject easier, wherein the second question comprises a lower level of difficulty than the question;
receiving, from the touch screen, a second input in response to the second question;
linking, by the system, the second input to the second node; and
scoring, by the system, the user's competence at the lower level based on a comparison between the link between the second input and the second node and a second correct link in response to the second question.

18. The method of claim 16, further comprising the step of providing, by the system, the question in response to an assumed level of knowledge,
wherein the assumed level of knowledge is determined based on a educational level associated with the user.

19. The method of claim 18, wherein the assumed level of knowledge is determined based on log-in credentials associated with the user.

20. The method of claim 16, further comprising the step of providing, by the system, the score associated with the user's competence on the touch screen.
